(19) United States
(12) Patent Application Publication
(10) Pub. No.: US 2008/0135741 A1
(43) Pub. Date: Jun. 12, 2008

(54) Method for providing light signals for photometers and a photometer

(75) Inventors: Jukka Tuunanen, Helsinki (FI); Henrik Johansson, Espoo (FI); Ville Saarainen, Helsinki (FI); Olli Myyrylainen, Helsinki (FI)

Correspondence Address: BIRCH STEWART KOLASCH & BIRCH, PO BOX 747, FALLS CHURCH, VA, 22040-0747, US

(73) Assignee: Thermo Fisher Scientific Oy

(21) Appl. No.: 11/984,935

(22) Filed: Nov. 26, 2007

(30) Foreign Application Priority Data
Dec. 7, 2006 (FI) 20065778

(51) Int. Cl. G01J 3/50

(52) U.S. Cl. 250/226

(57) ABSTRACT

The present invention relates to photometers wherein light signals on different wavelengths are directed to samples and a light scattered from or penetrated through the sample is measured with a photodetector. Method provides a required filtered light signal for a photometer (4). The method comprises providing a source of white light by a pulsed flash light source (7) and filtering the light signal for providing signals on different wavelengths by using multiple filters (6) arranged on a perimeter of a rotary filter disk (5). At least one filtered light signal is led to at least one photometer (4). The filter disk (5) Is rotated continuously for passing successive filters (6) over the path of light from the flash light source (7) to the photometer (4) and the flash light source (7) is triggered when a filter (6) providing the required wavelength of light is on the path of light from the flash light source (7) to the photometer (4).

The present invention relates to photometers wherein light signals on different wavelengths are directed to samples and a light scattered from or penetrated through the sample is measured with a photodetector.

### BACKGROUND OF THE INVENTION

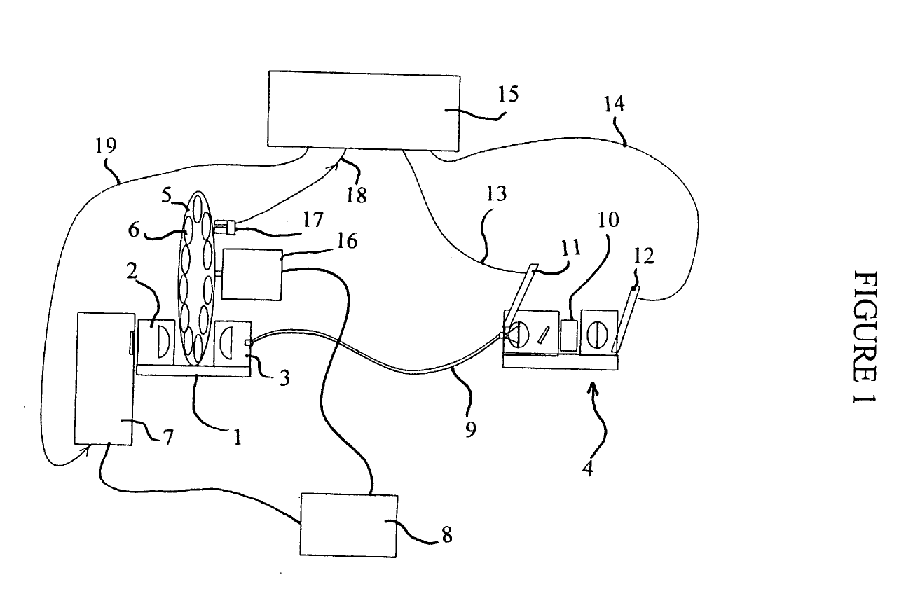

Photodetectors require for various measurements for different purposes different wavelengths of light. The light needed has been commonly provided by using a source of white light and filters that pass the wavelengths that are required for measurements. Since one photometer may perform several measurements on various wavelengths, many wavelengths are required. These can be easily provided by a rotary filter disk that has several filters on its perimeter. When a specific wavelength is required, a corresponding filter is rotated between the light source and light conduit, usually an optical fiber, and light having a required wavelength is transferred to the sample to be measured and finally to the photodetector performing the measurement. A rotary filter disk with a constantly lit light source provides a reasonable speed of operation but since the brightness of the continuously lit light is limited, the filter disk has to be stopped during measurement for a length of the measurement or the rotational speed of the filter disk has to be low enough to provide a pulse of filtered light that is long enough for the measurement required. An apparatus of this kind is described in WO 87/06695 (in particular; pages 20-22, FIG. 3).

Another way to divide the light of a light source into different wavelengths is to provide a flash tube and several optical fibers that direct the light from the flash tube to multiple photodetectors. Each optical fiber has a filter that provides the wavelength needed. In this case samples to be measured are rotated on a disk over the detectors and only one measurement on one wavelength is made on each detector. This type of arrangement is described in EP 0 185 405.

### SUMMARY OF THE INVENTION

According to the present invention, a flash tube having a short charging time and high flash frequency is used as a light source. A continuously rotating disk having multiple filters on its perimeter is used for filtering required wavelengths from the white light of the flash light source. The flash frequency of the light source is synchronized with the rotational speed of the continuously rotating disk so that the flash is triggered when the required filter is at a defined position in relation to the light source.

According to one preferred embodiment of the invention, the flash light source is triggered when a required filter is centered in relation to the light beam excited from the flash light source.

According to one further preferred embodiment, the rotation speed of the filter disk is synchronized with the flash frequency of the light source so that the time required for a subsequent filter to move on the path of light is same as the charging time of the flash light source.

According to the other aspects of the present invention, several flash light sources are placed on the perimeter of a single filter disk. Further, the angular position of the rotating disk is measured and the measurement result is used to provide a triggering signal to the flash light source.

The various embodiments of the invention provide essential benefits. First, the high brightness and luminous intensity of the flash light make it possible to do the measurement on the photodetector in a very short time compared to a continuously lit light source. Since the charging time of the flash is used for changing the filter in front of the light source, the measurements can be made on the maximum flash frequency of the light source. This makes most efficient use of the performance of the light source. The frequency of the measurements can be hundreds of Hz depending of the performance of the light source. The charge time of the light source is thus used for changing the filter and no waste time is generated. The invention can be utilized on any frequency of electromagnetic radiation, but usually the measurements are made using wavelengths that are on the area of visible light. However, ultraviolet and infrared light, as well as roentgen frequencies, are sometimes used also

In this document the perimeter of the filter disk is defined to be the circle on which the filters are positioned on the filter disk.

The flash frequency of the light source is the time needed for the flash to charge and provide a next flash after discharge.

White light is considered to be the electromagnetic radiation emitted by the light/radiation source in general and the filtered light is the light that has passed the filter. Thus, in limits of this document white light can be electromagnetic radiation on wavelengths of visible, ultraviolet, infrared or roentgen light, for example.

Other objects and features of the invention will become apparent from the following detailed description considered in conjunction with the accompanying drawings. It is to be understood, however, that the drawings are intended solely for purposes of illustration and not as a definition of the limits of the invention, for which reference should be made to the appended claims.

### BRIEF DESCRIPTION OF THE DRAWING

The drawing shows diagrammatically one embodiment of the invention.

### DETAILED DESCRIPTION OF THE PRESENTLY PREFERRED EMBODIMENTS

The drawing shows an apparatus for providing light signals according to the invention and a photodetector as well as control electronics. The apparatus for providing light signals is built on a base plate 1, on which optics 2 of providing a beam of white light are arranged as well as optics 3 for directing filtered light to a photodetector 4. The optics for white light 2 and for filtered light are arranged opposite to each other on same optical axis so that light beam exiting from the optics for white light 2 is directed to the optics for the filtered light 3. The white light optics 2 and the filtered light optics 3 are places at a distance from each other. A filter wheel 5 is placed between the optics 2, 3. The filter wheel 5 is a circular disk having multiple filters 6 on its perimeter. The filters 6 are placed on the edge of the filter disk 5 so that their center points are on a same circle. The circle on which the filters are placed is arranged to travel through the central axis of the light beam exiting from the optics 2 for white light and entering the optics 3 for filtered light. When a filter 6 is placed on the path of the light beam, it passes only a specific wavelength and thus changing the filter 6 can provide light signals for various measurements.

The light signal is provided by a pulsed flash lamp 7 that is fed from a power source 8. Xenon flash lamps are good sources of light and they have a high repetition rate of over 200 Hz. They generate relatively little heat compared to halogen lamps, which are an alternative for flash lamps that can be used.

The filtered light is directed through optics for filtered light 3 to a light path, which is led to a photodetector 4. The light path is preferably made of optical fiber 9. When the light enters the photodetector 4, it is divided to a reference signal and measurement signal. The measurement signal is directed through a cuvette 10 or other vessel containing the substance that is measured. The intensity of the reference light beam is measured by a detector board 11 for reference signal and intensity of the light passed through the cuvette 10 is measured by detector board 12 for measured light. The reference signal is fed to a control and measuring unit 15 through reference channel 13 and the measured signal through signal cannel. The control and measuring unit makes the calculations necessary for providing the measurement results and presenting them in desired readable format. The photodetector described herein is presented only as an example. The invention can be can be used in connection with any type of photodetector that requires light on different wavelengths for measurement.

The filter disk 5 is rotated by an electric motor 16 and the angular position and rotation speed of the disk is measured with optical sensor 17 and the information of these is sent to control and measurement unit 15 through synchronization channel 18. The unit 18 sends a trigger signal to flash lamp 7 through trigger channel 19.

The operation of the apparatus is based on continuous rotation of the filter disk 5 and fast charging and repetition time of the flash lamp 7. The angular position of the filter disk 5 is continuously detected by optoelectric sensor 17. The control and measuring unit 15 has or receives information of what wavelengths are needed for measurements that will be made with the photodetector 4 for different samples. Usually the samples are placed in cuvettes having several measuring cavities. For each cuvette and its sample cavity can be made one measurement on a specific wavelength or several measurements on various specific wavelengths. When the control and measuring unit 15 acknowledges that a cuvette and measuring cavity is ready for measurement in photodetector 4, it triggers the flash lamp 7 on such a position of the filter disk 5 that a filter 6 providing a specific wavelength for required measurement at the photodetector is aligned on the path of light between the optics 2, 3 for white and filtered light. Normally the flash lamp 7 is triggered when a required filter 6 is centered with the path of light. Alternatively some filters may have specific trigger points that are off-center.

The rotational speed of the filter disk 5 can be set to any desired level. However, on order to obtain benefits of high repetition time of the flash lamp and fast detection made possible by the high luminous intensity of the flash light source, the rotational speed of the filter disk should be so high, that a desired filter is rotated on the path of the white light about in the same time as the flash lamp 7 is charged. For example, the speed of filter disk 5 can be set so that the time elapsed needed for disk to rotate for between two successive filter is same or almost the same as the charge time of the flash lamp 7. In this case the flash may be triggered on every filter during one rotation of the filter disk 5 without causing a delay. However, usually different wavelengths for measurement are needed in random order, whereby higher rotational speed may be preferred. Continuous rotation and high repetition time of the flash lamp provide in any case a possibility to such a high rate of measurements that it is irrelevant if the filter disk is rotated several rounds between flashes. On the other hand, the time needed for any desired filter to turn on the light path should not exceed too much the charging time of the flash lamp. If the change time of the filters is more than 1-3 times the charge time of the lamp, it may be advisable to use a lamp having longer charge time, since such may be cheaper. In any case, the flash is triggered according to the angular position of the disk in a sequence that provides a required sequence of wavelengths.

The number of filters on the disk depends on the number of wavelengths needed for measurements. Usually one filter is “black”, i.e. one filter position does not let any light pass. This black filter is needed for measurement and elimination of background noise. The filter disk may also include several filters for one same wavelength if number of measurements done on this wavelength is greater than number of measurements made on other wavelength. This may speed up the measurement cycles since a dominant filter can be found faster. As a source of white radiation any flash radiation source can be used that provides wavelengths on a large enough interval for the measurements needed. The flash light source should preferably have a repetition time of hundreds of Hz, for example of 100 Hz at least and more preferably more than 200 Hz. The number of the light sources can be more than one or light from one light source can be directed to several filters by optical fibers, for example. In a same way, filtered light may be directed to more than one photodetector.

In order to be able to trigger the flash at a required filter, the angular position of the filter disk has to be known. In the example above, an optical sensor was used. One other way to obtain this information is to use an electric motor having an integrated angular detector or by using a step motor, wherein the angular position can readily be obtained from drive pulses of the motor.

Thus, while there have been shown and described and pointed out fundamental novel features of the invention as applied to a preferred embodiment thereof, it will be understood that various omissions and substitutions and changes in the form and details of the method and apparatus may be made by those skilled in the art without departing from the spirit of the invention. For example, it is expressly intended that all combinations of those elements and/or method steps which perform substantially the same results are within the scope of the invention. Substitutions of the elements from one described embodiment to another are also fully intended and contemplated. It is also to be understood that the drawings are not necessarily drawn to scale but they are merely conceptual in nature. It is the intention, therefore, to be limited only as indicated by the scope of the claims appended hereto.

What is claimed is:

1. Method for providing a required filtered light signal for a photometer (4), the method comprising:
providing a source of white light by a pulsed flash light source (7),
filtering the light signal for providing signals on different wavelengths by using multiple filters (6) arranged on a perimeter of a rotary filter disk (5),
leading at least one filtered light signal to at least one photometer (4),
rotating the filter disk (5) continuously for passing successive filters (6) over the path of light from the flash light source (7) to the photometer (4),
triggering the flash light source (7) when a filter (6) providing the required wavelength of light is on the path of light from the flash light source (7) to the photometer (4).

2. Method according to claim 1, characterized in triggering the flash light source (7) when a filter (6) providing the required wavelength of light is centered on the path of light from the flash light source (7) to the photometer (4).

3. Method according to claim 1 or 2, characterized in detecting the angular position of the filter disk (5) and triggering the flash light source according to the information of angular position.

4. Method according to any of the claims 1-3, characterized in that the rotation speed of the filter disk (5) is matched with the flash frequency of the flash light source 87) so that the time required for a subsequent filter (6) to move on the path of light is same as the charging time of the flash light source (7).

5. Method according to any of the claims 1-4, characterized in using a xenon flash lamp (7) as a source of white light.

6. Method according to any of the claims 1-5, characterized in using a flash light source (7) having a repetition frequency of 100 Hz at least, preferably 200 Hz at least.

7. Apparatus for providing a required filtered light signal for a photometer (4), the apparatus comprising:
a flash light source (7) for providing a source of white light,
means (2) for arranging a path of light from the flash light source (7),
a rotary filter disk (5), arranged on the path of light from the flash light source (7)
multiple filters (6) arranged on a perimeter of the rotary filter disk (5), for filtering the light signal from the flash light source (7) for providing signals of light on different wavelengths,
means for rotating the filter disk (5) continuously for passing successive filters (6) over the path of light from the flash light source (7),
means (15, 17) for triggering the flash light source (7) when a filter (6) providing the required wavelength of light is on the path of light from the flash light source (7).
